(19) United States
(12) Patent Application Publication
(10) Pub. No.: US 2008/0296387 A1
(43) Pub. Date: Dec. 4, 2008

(54) Point-of transaction workstation for electro-optically reading one-dimensional indicia, including image capture of two-dimensional targets

(76) Inventors: Robert Sanders, St. James, NY (US); Edward Barkan, Miller Place, NY (US)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 11/807,945

(22) Filed: May 30, 2007

(51) Int. Cl. G06K 7/10

(52) U.S. Cl. 235/462.41

(57) ABSTRACT

A solid-state imager and an electro-optical reader are mounted behind respective windows at a point-of-transaction workstation for capturing images of diverse targets useful for customer identification, customer payment validation, and operator surveillance, and for reading coded indicia. Each window allows light to pass therethrough to only one of the reader and the imager.

### BACKGROUND OF THE INVENTION

1. Field of the Invention

The present invention generally relates to an electro-optical reader for reading indicia and, more particularly, to a point-of-transaction workstation for reading not only one-dimensional indicia, such as bar code symbols, but also for reading one- or two-dimensional indicia by image capture, as well as capturing images of other two-dimensional targets, such as signatures, checks, credit cards, debit cards, drivers' licenses, and people.

2. Description of the Related Art

Flat bed laser readers, also known as horizontal slot scanners, have been used to electro-optically read one-dimensional bar code symbols, particularly of the Universal Product Code (UPC) type, at a point-of-transaction workstation in supermarkets, warehouse clubs, department stores, and other kinds of retailers for many years. As exemplified by U.S. Pat. No. 5,059,779; U.S. Pat. No. 5,124,539 and U.S. Pat. No. 5,200,599, a single, horizontal window is set flush with, and built into, a horizontal countertop of the workstation. Products to be purchased bear an identifying symbol and are typically slid across the horizontal window through which a multitude of scan lines is projected in a generally upwards direction. When at least one of the scan lines sweeps over a symbol associated with a product, the symbol is processed and read.

The multitude of scan lines is generated by a scan pattern generator which includes a laser for emitting a laser beam at a mirrored component mounted on a shaft for rotation by a motor about an axis. A plurality of stationary mirrors is arranged about the axis. As the mirrored component turns, the laser beam is successively reflected onto the stationary mirrors for reflection therefrom through the horizontal window as a scan pattern of the scan lines.

It is also known to provide a point-of-transaction workstation with a generally vertical window that faces an operator at the workstation. The generally vertical window is oriented generally perpendicularly to the horizontal window, or is slightly rearwardly inclined. The scan pattern generator within this dual window or bi-optic workstation also projects the multitude of scan lines in a generally outward direction through the vertical window toward the operator. The generator for the vertical window can be the same as or different from the generator for the horizontal window. The operator slides the products past either window from right to left, or from left to right, in a “swipe” mode. Alternatively, the operator merely presents the symbol on the product to the center of either window in a “presentation” mode. The choice depends on operator preference or on the layout of the workstation.

Sometimes, the vertical window is not built into the workstation as a permanent installation. Instead, a vertical slot scanner is configured as a portable reader which is placed on the countertop of an existing horizontal slot scanner.

Each product must be oriented by the operator with the symbol facing away from the operator and directly towards either window. Hence, the operator cannot see exactly where the symbol is during scanning. In typical “blind-aiming” usage, it is not uncommon for the operator to repeatedly swipe or present a single symbol several times before the symbol is successfully read, thereby slowing down transaction processing and reducing productivity.

The blind-aiming of the symbol is made more difficult because the position and orientation of the symbol are variable. The symbol may be located low or high, or right to left, on the product, or anywhere in between. The symbol may be oriented in a “picket fence” orientation in which the elongated parallel bars of the one-dimensional UPC symbol are vertical, or in a “ladder” orientation in which the symbol bars are horizontal, or at any orientation angle in between.

In such an environment, it is important that the scan lines located at, and projected from, either window provide a full coverage scan zone which extends down as close as possible to the countertop, and as high as possible above the countertop, and as wide as possible across the width of the countertop. The scan patterns projected into space in front of the windows grow rapidly in order to cover areas on products that are positioned not on the windows, but several inches therefrom. The scan zone must include scan lines oriented to read symbols positioned in any possible way across the entire volume of the scan zone.

As advantageous as these point-of-transaction workstations are in processing transactions involving products associated with one-dimensional symbols each having a row of bars and spaces spaced apart along one direction, the workstations cannot process two-dimensional symbols, such as Code 39 which introduced the concept of vertically stacking a plurality of rows of bar and space patterns in a single symbol. The structure of Code 49 is described in U.S. Pat. No. 4,794,239. Another two-dimensional code structure for increasing the amount of data that can be represented or stored on a given amount of surface area is known as PDF417 and is described in U.S. Pat. No. 5,304,786. Such two-dimensional symbols are generally read by electro-optical readers operative for projecting a laser beam as a raster of scan lines, each line extending in one direction over a respective row, and all the lines being spaced apart along a height of the two-dimensional symbol in a generally perpendicular direction.

Both one- and two-dimensional symbols can also be read by employing solid-state imagers. For example, an image sensor device may be employed which has a one- or two-dimensional array of cells or photosensors which correspond to image elements or pixels in a field of view of the device. Such an image sensor device may include a one- or two-dimensional charge coupled device (CCD) or a complementary metal oxide semiconductor (CMOS) device and associated circuits for producing electronic signals corresponding to a one- or two-dimensional array of pixel information for a field of view.

It is therefore known to use a solid-state device for capturing a monochrome image of a symbol as, for example, disclosed in U.S. Pat. No. 5,703,349. It is also known to use a solid-state device with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

It is also known to install an imager, as embodied in a consumer digital camera, in a point-of-transaction workstation, as disclosed in U.S. Pat. No. 7,191,947. However, the imager and the laser scan pattern generator share one of the windows, that is, they both scan a portion of the same window. This results in redundant scanning and processing at that portion of the shared window, which is an inefficient use of processing resources. Also, by having one or more laser scan pattern generators in the workstation, the overall system is complex and relatively expensive.

### SUMMARY OF THE INVENTION

One feature of this invention resides, briefly stated, in an arrangement for, and a method of, processing transactions, comprising a stationary point-of-transaction workstation having a plurality of windows or ports, and an electro-optical reader mounted within the workstation, the reader being operative for projecting a laser beam light as a plurality of scan lines exclusively through only one of the windows, and for electro-optically reading a one-dimensional indicium associated with a transaction presented at the one window when at least one of the scan lines is swept across at least a part of the one-dimensional indicium. By way of example, the one-dimensional indicium is a UPC symbol associated with an object passing through the workstation. In the preferred application, the object is a product to be purchased by a consumer, and the workstation is installed in a retail establishment, such as a supermarket.

A one- or two-dimensional, solid-state imager, preferably a charge coupled device (CCD) array, is also mounted at the workstation, and is operative for capturing light from a one- or two-dimensional target exclusively through another of the windows. In accordance with a feature of this invention, each window allows the light to pass therethrough to only one of the reader and the imager. Hence, the imager and the reader do not, as taught in the prior art, share one of the windows, and they do not both scan a portion of the same window. Redundant scanning and processing at a shared window is avoided, thereby utilizing processing resources more efficiently, and simplifying the overall system.

The target may be a two-dimensional symbol to be electro-optically read. The target may also be a personal check, a credit card, or a debit card presented by the consumer for payment of the products being purchased. The target may also be a signature of the consumer, or the consumer himself or herself. The target may also be a form of identification of the consumer, such as a driver's license, especially one on which a two-dimensional symbol is pre-printed, for validating one's identity and age. The target may even be the operator himself or herself for use in video surveillance for security purposes.

The imager is preferably associated with a high-speed illuminator to enable the image of the target to be acquired in a very short period of time, for example, on the order of 100 microseconds, so that the target image is not blurred even if there is relative motion between the imager and the target.

One of the windows is located in a horizontal plane, and one or more other windows, preferably recessed, lies in a generally upright plane that intersects the horizontal plane. A weighing scale may be mounted at the workstation, and one of the windows may be incorporated into the scale. A register may also be mounted at the workstation, and one of the windows may be incorporated into the register. Another solid-state imager is mounted in the register for capturing light from the target preferably located at the horizontal plane. If a solid-state imager is mounted below the horizontal plane, then room exists for a drawer to be mounted below the horizontal plane. In addition, a radio frequency identification (RFID) reader may be mounted at the workstation.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a dual window, bi-optic, point-of-transaction workstation operative for reading one-dimensional indicia and for capturing light from two-dimensional targets in accordance with this invention;

FIG. 2 is a part-sectional, part-diagrammatic view of the workstation of FIG. 1;

FIG. 3 is a view similar to FIG. 2 of another embodiment of this invention;

FIG. 4 is a view similar to FIG. 2 of still another embodiment of this invention;

FIG. 5 is a view similar to FIG. 2 of yet another embodiment of this invention;

FIG. 6 is a view similar to FIG. 2 of an additional embodiment of this invention; and

FIG. 7 is a block circuit diagram of various components of the workstation of FIG. 1.

### DETAILED DESCRIPTION OF THE PREFERRED EMBODIMENTS

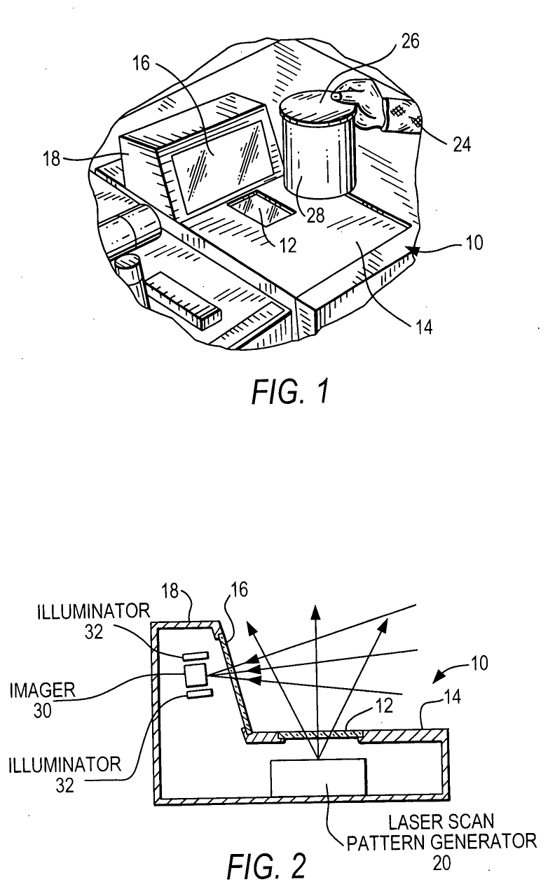

FIG. 1 depicts a dual window, bi-optic, point-of-transaction workstation 10 used by retailers to process transactions involving the purchase of products bearing an identifying symbol, typically the UPC symbol described above. Workstation 10 has a horizontal window 12 set flush into a countertop 14, and a vertical or generally vertical (referred to as “vertical” or “upright” hereinafter) window 16 set flush, or recessed, into a raised housing 18 above the countertop.

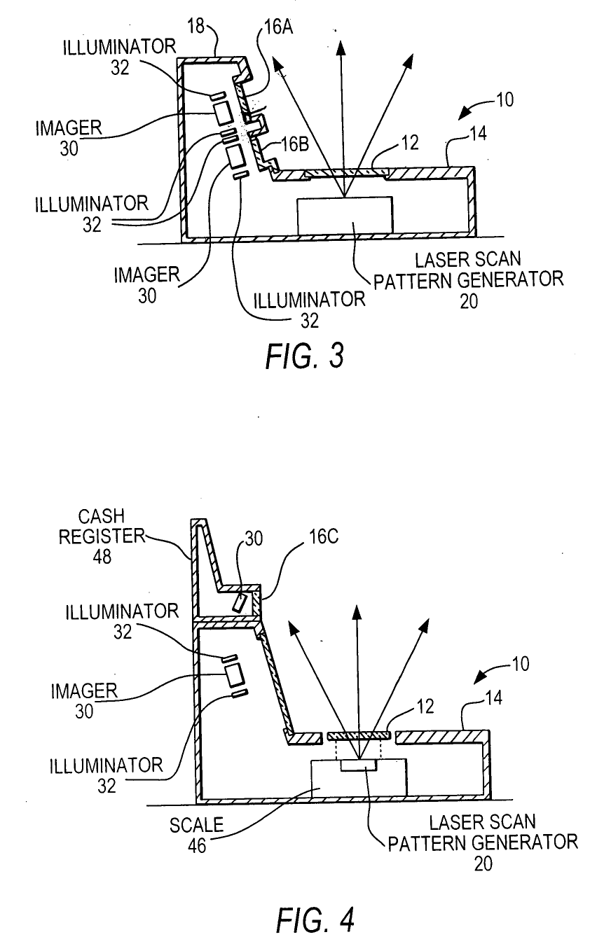

A laser scan pattern generator 20 or electro-optical reader, shown schematically in FIG. 2, is mounted in the workstation behind one of the windows, especially the horizontal window 12, and is operative to project generally upwards out of the horizontal window 12 a laser beam light as a set of scan lines to read one-dimensional UPC symbols. An imager 30 including an illuminator 32 are also mounted at the workstation, for capturing light from a one- or two-dimensional target which, as described below, can be a two-dimensional symbol. The imager 30 is a solid-state area array, preferably a CCD or CMOS array. The imager 30 is preferably mounted behind another of the windows, especially the upright window 16. One or more imagers, as described below in connection with FIG. 3, can be employed, with an imager at each window. Each illuminator 32 is preferably a plurality of light sources, e.g., light emitting diodes (LEDs), arranged in an annulus around each imager 30 to uniformly illuminate the target, as further described below.

In use, an operator 24, such as a person working at a supermarket checkout counter, processes a product 26 bearing a UPC symbol 28 thereon, past the windows 12, 18 by swiping the product across a respective window in the abovementioned swipe mode, or by presenting the product at the respective window in the abovementioned presentation mode. If the symbol 28 is located on the bottom of the product, then one of the scan lines projected through the horizontal window 12 will traverse the symbol. If the symbol 28 is located on the side of the product, then the imager will capture light from the symbol through the upright window 16.

In accordance with one feature of this invention, each window 12, 16 allows the light to pass therethrough to only one of the reader 20 and the imager 30. Hence, the imager 30 and the reader 20 do not, as taught in the prior art, share one of the windows, and they do not both scan a portion of the same window. Redundant scanning and processing at a shared window is avoided, thereby utilizing processing resources more efficiently, and simplifying the overall system.

FIG. 3 depicts a workstation similar to that shown in FIG. 2, except that there are two upright smaller windows 16A, 16B, and there are two imagers 30, one for each window 16A, 16B. Each imager has its own field of view and is oriented to face the product in different directions. Preferably, each window 16A, 16b is recessed to prevent the windows from being scratched or broken, or covered with a contaminant. It is also contemplated that each window be eliminated and replaced by an open port through which the light is free to pass.

FIG. 4 depicts a workstation similar to that shown in FIG. 2, except that a weighing scale 46 and a cash register 48 are mounted at the workstation. The reader 20 is preferably incorporated inside the scale, and the horizontal window 12 advantageously serves not only as a weighing platter for supporting a product to be weighed, but also allows the laser beam light to pass therethrough. The register 48 has its own window 16C behind which an imager 30 is mounted (the illuminator 32 being omitted for clarity). The imager 30 within the register is angularly turned to face outwardly and downwardly, preferably at the horizontal window 12 for reading symbols at the top of a product, or for reading a two-dimensional target, such as a two-dimensional symbol on a driver's license, facing upwardly. The register 48 can sit atop the housing 18, or be integrated therewith.

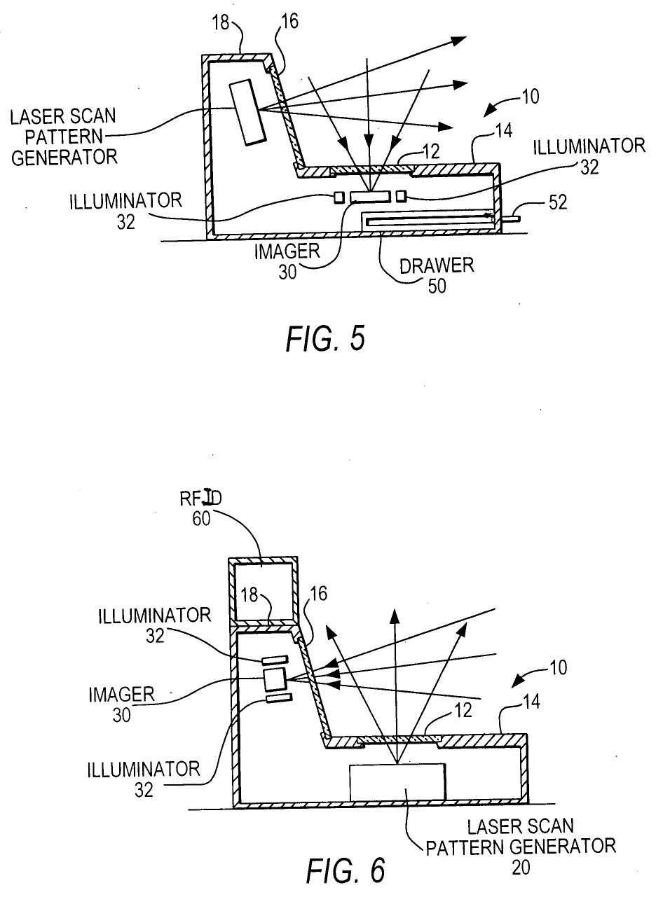

FIG. 5 depicts a workstation similar to that shown in FIG. 2, except that the positions of the imager 30 and the pattern generator 20 have been reversed. The imager 30 is more compact than the pattern generator. As a result, sufficient room exists for a drawer 50 to be pulled out of the workstation by a handle 52. The drawer is not too low and is within ready access of the operator.

FIG. 6 depicts a workstation similar to that shown in FIG. 2, except that a radio frequency identification (RFID) reader 60 is mounted at the workstation. The reader 60 can be mounted at any location and not only atop the housing 18, as shown.

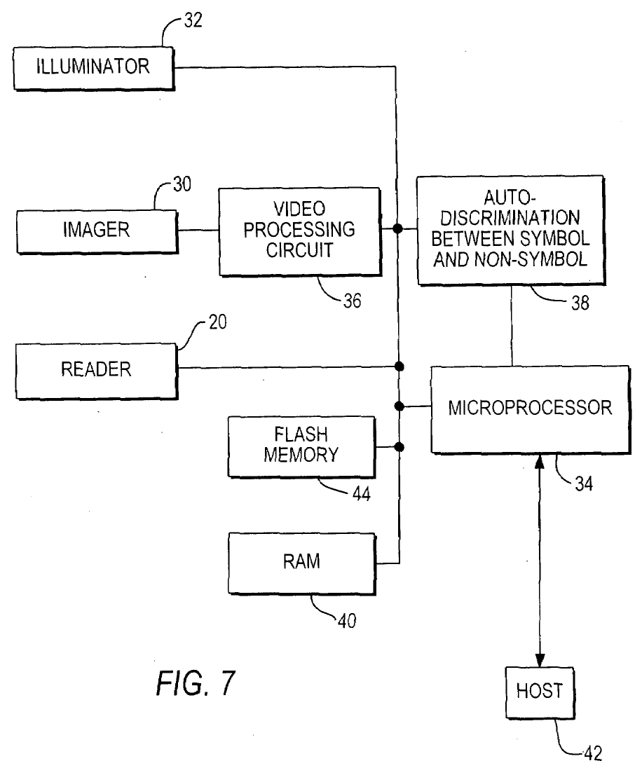

As shown in FIG.7, the reader 20, the imager 30, and the illuminator 32 are operatively connected to a microprocessor 34 operative for controlling the operation of these components. Preferably, the microprocessor is the same as the one used for decoding light scattered from the indicia and for processing the captured target images.

In operation, the microprocessor 34 sends a command signal to the illuminator 32 to pulse the LEDs for a short time period of 100 microseconds or less, and energizes the imager 30 to collect light from a target only during said time period. By acquiring a target image during this brief time period, the image of the target is not blurred even in the presence of relative motion between the imager and the target.

There are several different types of targets which have particular utility for the enhancement of the operation of the workstation. The target may be a personal check, a credit card, or a debit card presented by a customer for payment of the products being purchased. The operator need only swipe or present these payment targets at the window 16 for image capture.

The target may also be a signature, a driver's license, or the consumer himself or herself. Capturing an image of the driver's license is particularly useful since many licenses are encoded with two-dimensional indicia bearing age information, which is useful in validating a customer's age and the customer's ability to purchase age-related products, such as alcoholic beverages or tobacco products.

The target may be the operator himself or herself, which is used for video surveillance for security purposes. Thus, it can be determined if the operator is actually scanning the products, or passing them around the window in an effort to bypass the window and not charge the customer in a criminal practice known in retailing as “sweethearting”.

The target may, of course, be two-dimensional symbols whose use is becoming more widespread, especially in manufacturing environments and in package delivery. Sometimes, the target includes various lengths of truncated symbols of the type frequently found on frequent shopper cards, coupons, loyalty cards, in which case the area imager can read these additional symbols.

The energization of the imager 30 can be manual and initiated by the operator. For example, the operator can depress a button, or a foot pedal, or simply open the drawer 50 of the workstation. The energization can also be automatic such that the imager operates in a continuous image acquisition mode which, of course, is the desired mode for video surveillance of the operator, as well as for decoding two-dimensional symbols.

The continuous video stream generated during a continuous image acquisition mode can, however, overload a conventional video processing circuit and, as a result, cause some frames of the target image to be dropped. A high-speed video processing circuit 36 receives the continuous video stream and, with the aid of an auto-discrimination circuit 38, determines and selects which images in the stream are one-dimensional symbols, which images are two-dimensional symbols, and which images are not symbols at all. The auto-discrimination circuit 38, after such selection, transfers only the symbols to the microprocessor 34 for decoding. The software to be downloaded to the auto-discrimination circuit is stored in the flash memory 44. This dramatically reduces the computational burden on the microprocessor 34. The non-symbol images can be directly transferred to a memory, such as RAM 40, or directly routed by the microprocessor to a host 42. The method used for autodiscrimination between one- and two-dimensional symbols is described in U.S. Pat. No. 6,250,551, the entire contents of which are incorporated herein by reference thereto.

It will be understood that each of the elements described above, or two or more together, also may find a useful application in other types of constructions differing from the types described above.

While the invention has been illustrated and described as embodied in a point-of transaction workstation for electro-optically reading one-dimensional indicia, including image capture of two-dimensional targets, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. An arrangement for processing transactions, comprising:
a stationary workstation having a plurality of windows;
an electro-optical reader mounted within the workstation, for projecting a laser beam light as a plurality of scan lines exclusively through only one of the windows, and for electro-optically reading a one-dimensional indicium associated with a transaction presented at the one window when at least one of the scan lines is swept across at least a part of the one-dimensional indicium; and
a solid-state imager mounted at the workstation, for capturing light from a target at the workstation exclusively through another of the windows, each window allowing the light to pass therethrough to only one of the reader and the imager.

2. The arrangement of claim 1, wherein the one window is located in a horizontal plane, and wherein the another window lies in a generally upright plane that intersects the horizontal plane.

3. The arrangement of claim 1, wherein the imager includes a two-dimensional, charge coupled device (CCD) array.

4. The arrangement of claim 1, wherein the imager includes an illuminator for illuminating the target in a time period less than 100 microseconds, and wherein the imager captures the light only during said time period:

5. The arrangement of claim 1, wherein the transaction is a purchase of goods passed by the windows, and wherein the target is one of a personal check and a card presented by a consumer for payment of the goods being purchased.

6. The arrangement of claim 5, wherein the target is also one of a signature, a driver's license, and the consumer.

7. The arrangement of claim 5, wherein the transaction is a purchase of goods passed by an operator past the windows, and wherein the target is an operator.

8. The arrangement of claim 1, wherein the target is a two-dimensional indicium, at least one of the indicia being associated with the transaction, and a common processor operatively connected with the reader and the imager for processing said at least one of the indicia to be electro-optically read.

9. The arrangement of claim 1, wherein another solid-state imager is mounted at the workstation for capturing light from a two-dimensional target at the workstation exclusively through still another of the windows, each window allowing the light to pass therethrough to only one of the reader and the imagers.

10. The arrangement of claim 1, and a weighing scale at the workstation, and wherein one of the windows is incorporated into the scale.

11. The arrangement of claim 1, and a register at the workstation, and wherein one of the windows is incorporated into the register.

12. The arrangement of claim 1, wherein one of the windows lies in a horizontal plane, and wherein a register is located above the horizontal plane, and wherein another solid-state imager is mounted in the register for capturing light from a target at the horizontal plane.

13. The arrangement of claim 1, wherein one of the windows lies in a horizontal plane, and wherein the solid-state imager is mounted below the horizontal plane, and a drawer mounted below the horizontal plane.

14. The arrangement of claim 1, wherein at least one of the windows is recessed within the workstation.

15. The arrangement of claim 1, and a radio frequency identification (RFID) reader mounted at the workstation.

16. An arrangement for processing transactions, comprising:
a stationary workstation having a plurality of ports;
reading means mounted within the workstation, for projecting a laser beam light as a plurality of scan lines exclusively through only one of the ports, and for electro-optically reading a one-dimensional indicium associated with a transaction presented at the one port when at least one of the scan lines is swept across at least a part of the one-dimensional indicium; and
imaging means mounted at the workstation, for capturing light from a target at the workstation exclusively through another of the ports, each port allowing the light to pass therethrough to only one of the reading means and the imaging means.

17. A method of processing transactions, comprising the steps of:
mounting a plurality of windows at a stationary workstation;
projecting a laser beam light as a plurality of scan lines exclusively through only one of the windows, and electro-optically reading with a reader a one-dimensional indicium associated with a transaction presented at the one window when at least one of the scan lines is swept across at least a part of the one-dimensional indicium; and
capturing light from a target at the workstation exclusively through another of the windows with a solid-state imager mounted at the workstation, each window allowing the light to pass therethrough to only one of the reader and the imager.

18. The method of claim 17, and locating the one window in a horizontal plane, and positioning the another window to lie in a generally upright plane that intersects the horizontal plane.

19. The method of claim 17, wherein the capturing step is performed by a two-dimensional, charge coupled device (CCD) array.

20. The method of claim 17, and illuminating the target in a time period less than 100 microseconds, and wherein the capturing step is performed by capturing the light only during said time period.

21. The method of claim 17, wherein the transaction is a purchase of goods passed by the windows, and wherein the target is one of a personal check and a card presented by a consumer for payment of the goods being purchased.

22. The method of claim 21, wherein the target is also one of a signature, a driver's license, and the consumer.

23. The method of claim 21, wherein the transaction is a purchase of goods passed by an operator past the windows, and wherein the target is an operator.

24. The method of claim 17, wherein the target is a two-dimensional indicium, at least one of the indicia being associated with the transaction, and the step of processing said at least one of the indicia to be electro-optically read.

25. The method of claim 17, and mounting another solid-state imager at the workstation for capturing light from a two-dimensional target at the workstation exclusively through still another of the windows, each window allowing the light to pass therethrough to only one of the reader and the imagers.

26. The method of claim 17, and mounting a weighing scale at the workstation, and incorporating one of the windows into the scale.

27. The method of claim 17, and mounting a register at the workstation, and incorporating one of the windows into the register.

28. The method of claim 17, and positioning one of the windows to lie in a horizontal plane, and locating a register above the horizontal plane, and mounting another solid-state imager in the register for capturing light from a target at the horizontal plane.

29. The method of claim 17, and positioning one of the windows to lie in a horizontal plane, and mounting the solid-state imager below the horizontal plane, and mounting a drawer below the horizontal plane.

30. The method of claim 17, and recessing at least one of the windows within the workstation.

31. The method of claim 17, and mounting a radio frequency identification (RFID) reader at the workstation.
